(19) United States
(12) Patent Application Publication
(10) Pub. No.: US 2018/0211427 A1
(43) Pub. Date: Jul. 26, 2018

(54) GENERATING AND PROVIDING LAYERS FOR MAPS

(71) Applicant: Microsoft Technology Licensing, LLC, Redmond, WA (US)

(72) Inventors: Felix Gerard Torquil Ifor Andrew, Seattle, WA (US); Jeff West, Sammamish, WA (US); Chad Estes, Woodinville, WA (US)

(21) Appl. No.: 15/411,394

(22) Filed: Jan. 20, 2017

(51) Int. Cl. G06T 11/60

(52) U.S. Cl. CPC G06T 11/60

(57) ABSTRACT

A map application is provided that allows a user to create layers that can be used to modify a map. A layer may include features such as points of interest, routes, and polygons that are created or selected by the user. When the user enables a created layer, the generated features are displayed on the map until the user chooses to disable the layer. The features that are displayed in a layer are independent of any features currently being displayed on the map. The features associated with a layer may be static or may be dynamic. Layers may be shared with other users, and any changes made to a layer by an owner or creator of the layer may be pushed or provided to some or all of the users of the layer.

### BACKGROUND

Map applications are a popular type of application, with a variety of uses. For example, a user may use a map application to determine directions, or may use the map application to determine restaurants, banks, drug stores, and other businesses near a current location. Map applications are commonly integrated into smart phones, tablets, and vehicle navigation systems, and may be accessed by any computing device though the Internet.

While such map applications are ubiquitous, there currently is no easy way for users to quickly add or remove information from a map. For example, a user may frequently use a map application to view local restaurants and to view local running routes. However, each time the user desires to use the map application to either view local restaurants or to view local running routes, the user must either provide a query such as “restaurants” into the map application or must load the local running routes from an external source. Moreover, there is no easy way for the user to quickly view both local restaurants and local routes simultaneously on a map, or to quickly incorporate both local restaurants and local routes onto a map where the user is viewing other unrelated features.

### SUMMARY

A map application is provided that allows a user to create layers that can be used to modify a map. A layer may include features such as points of interest, routes, and polygons that are created or selected by the user. When the user enables a created layer, the features are displayed on the map until the user chooses to disable the layer. The features that are displayed in a layer are independent of any features currently being displayed on the map. The features associated with a layer may be static or may be dynamic. Layers may be shared with other users, and any changes made to a layer by an owner or creator of the layer may be pushed or provided to some or all of the users of the layer.

In an implementation, a system for generating a layer for a map and for providing the generated layer is provided. The system includes at least one computing device and a map engine. The map engine may be adapted to: receive a selection of a map; receive an indication of at least one route on the map; receive an indication of at least one point of interest on the map; receive an indication of at least one polygon on the map; generate a layer for the selected map comprising the at least one route, the at least one point of interest, and the at least one polygon; and provide the generated layer.

In an implementation, a system for selecting a layer for a map and for displaying the selected layer on the map is provided. The system may include at least one computing device and a map engine. The map engine may be adapted to: receive a selection of a map comprising a first plurality of features; display the first plurality of features of the map; receive a selection of a layer comprising a second plurality of features, wherein the second plurality of features includes at least one dynamic feature; and in response to the selection of the layer: request content for the at least one dynamic feature; receive the content for the at least one dynamic feature; and display the second plurality of features on the map with the first plurality of features, wherein the second plurality of features includes the content for the at least one dynamic feature.

In an implementation, a method for generating a layer for a map and for displaying the layer on the map is provided. The method includes receiving indications of a plurality of features on a map by a computing device; generating a layer for the map comprising the plurality of features by the computing device; providing the generated layer to a plurality of users by the computing device; receiving a change to one or more of the plurality of features by the computing device; and in response to the received change, providing an update to one or more users of the plurality of users by the computing device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for generating and distributing layers for a map application;

FIG. 2 is an illustration of an implementation of an exemplary map engine;

FIG. 3-9 are illustrations of example user interfaces for viewing a map and for generating layers;

FIG. 10 is an operational flow of an implementation of a method for generating a layer and for updating the layer based on a received change;

FIG. 11 is an operational flow of an implementation of a method for receiving a layer and for displaying a map with the received layer;

FIG. 12 is an operational flow of an implementation of a method for displaying a map with a received layer; and

FIG. 13 shows an exemplary computing environment in which example embodiments and aspects may be implemented.

### DETAILED DESCRIPTION

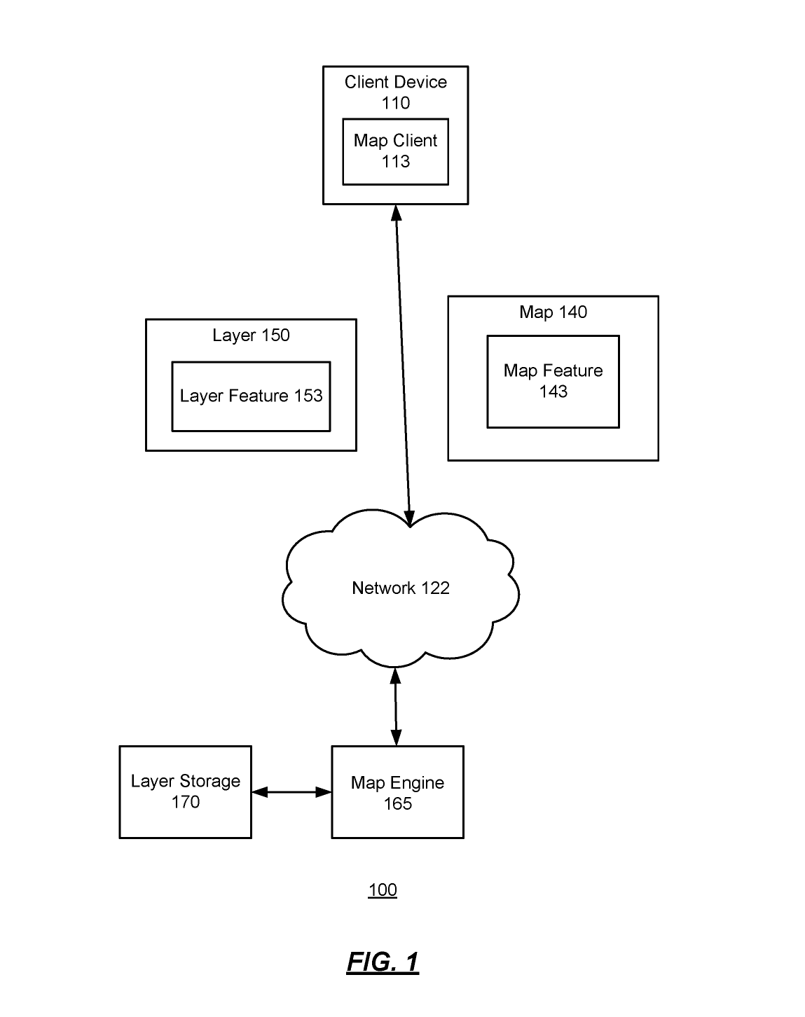

FIG. 1 is an illustration of an exemplary environment 100 for generating and distributing layers for a map application. The environment 100 may include a map engine 165 and one or more client devices 110 in communication through a network 122. The network 122 may be a variety of network types including the public switched telephone network (PSTN), a cellular telephone network, and a packet switched network (e.g., the Internet). Although only one client device 110 and one map engine 165 are shown in FIG. 1, there is no limit to the number of client devices 110 and map engines 165 that may be supported.

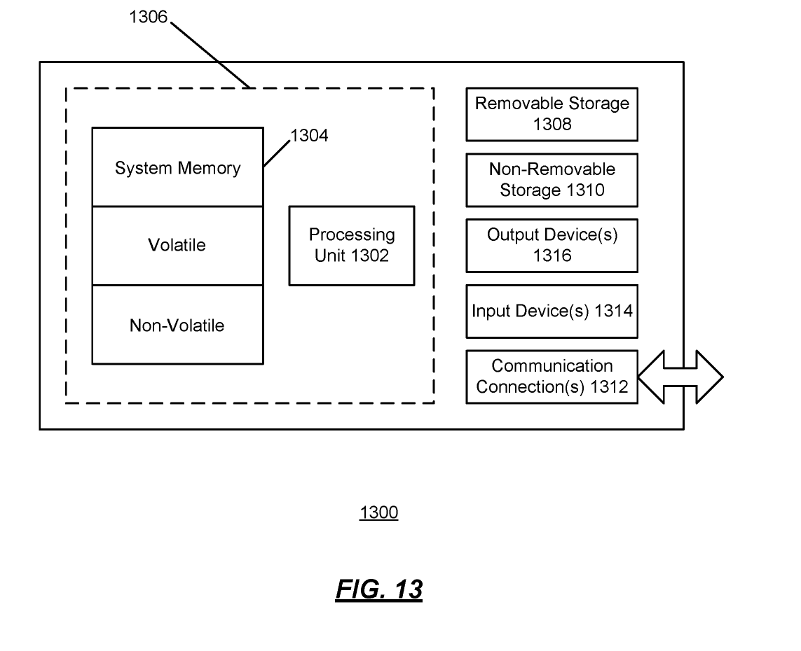

The client device 110 and the map engine 165 may be implemented using a variety of computing devices such as smart phones, desktop computers, laptop computers, tablets, vehicle navigation systems, and video game consoles. Other types of computing devices may be supported. A suitable computing device is illustrated in FIG. 13 as the computing device 1300.

Each client device 110 may further include a map client 113. The map client 113 may be used by a user of the client device 110 to view and interact with one or more maps 140. Depending on the implementation, the map client 113 may be, or may be part of, a map application. An example map application is the map application integrated into most smart phones and tablet computers.

A map 140 may include a plurality of map features 143. The map features 143 may include roads, points of interest, bodies of water, mountain ranges, parks, forests, the current or starting location of the user, a destination location, and any other place or thing that is typically rendered on a map 140. The map features 143 may also include particular types of businesses or entities such as hospitals, supermarkets, restaurants, dry cleaners, drug stores, school, libraries, and community centers. Other map features 143 may be supported.

One drawback associated with current map applications is that there exists no easy way for a user combine or link map features 143 together such that the user can easily enable or disable the grouped map features 143. For example, a user of a client device 110 such as a smart phone may frequently use their map client 113 to find nearby banks and restaurants. To find banks, the user uses the map client 113 to enter the query “Bank”, and is then provided a map 140 that includes map features 143 that are banks. Similarly, to find restaurants, the user uses the map client 113 to enter the query “Restaurant”, and is then provided a map 140 that includes map features 143 that are restaurants.

In the example described above, each time the user desires to find a restaurant or a bank, the user is forced to re-submit their queries using their map clients 113. Moreover, it may not be possible for the user to view the results of both searches on the map 140 simultaneously.

Accordingly, to solve some or all of the current drawbacks associated with maps 140 and map application, the environment 100 may include the map engine 165. The map engine 165 may allow users to generate, use, and distribute what are referred to herein as layers 150. A layer 150 may comprise a collection of layer features 153. The layer features 153 may be similar to the map features 143 and may include places or things that are typically rendered on a map 140.

Depending on the implementation, a user may create a layer 150 by selecting a plurality of map features 143 for the layer 150. The map engine 165 may save the selected plurality of map features 143 as the layer features 153 for the layer 150. The map engine 165 may allow the user to add or remove layer features 153. The generated layer 150 may be stored by the map engine 165 in a layer storage 170.

Once a layer 150 is created, a user may activate the layer 150 using their map client 113, and in response, the layer features 153 associated with the layer 150 may be rendered and displayed on the map 140. Depending on the implementation, the rendering and displaying of the layer features 153 may not affect any map features 143 that were displayed or rendered on the map 140 before the user activated the layer 150. When the user no longer desires to view the layer 150, the user may deactivate the layer 150 using their map client 113, and in response, the layer features 153 associated with the layer 150 may be removed from the map 140.

Continuing the example described above, the user who frequently searched for restaurants and banks may create a layer 150 that includes selected banks and restaurants as the layer features 153. When the user is later looking for a bank or a restaurant, the user may activate the layer 150, and the layer features 153 including the banks and restaurants may be displayed to the user on the map 140. When the user no longer desires to view the banks and restaurants, the user may disable the layer 150, and the bank and restaurant layer features 153 may be removed from the map 140.

The map engine 165 may allow users to share generated layers 150 with other users. A user may send links to a generated layer 150 to one or more contacts in a social networking application or other type of application. Each contact may download the layer 150 from the map engine 165.

For example, a user who lives in New York may generate a layer 150 that includes layer features 153 such as walking routes that the user prefers, and restaurants and shops that the user recommends. The user may share the layer 150 with friends who are visiting New York from out of town. When the friends are navigating New York using a client device 110 such as a smart phone, the friends may activate the layer 150 to view layer features 153 such as recommended walking routes, restaurants, and shops on their map 140. Moreover, because the layer 150 does not overwrite or interfere with existing map features 143 on the map 140, the layer 150 can be viewed along with directions or other information that the friends were viewing on their map 140 before they activated the layer 150.

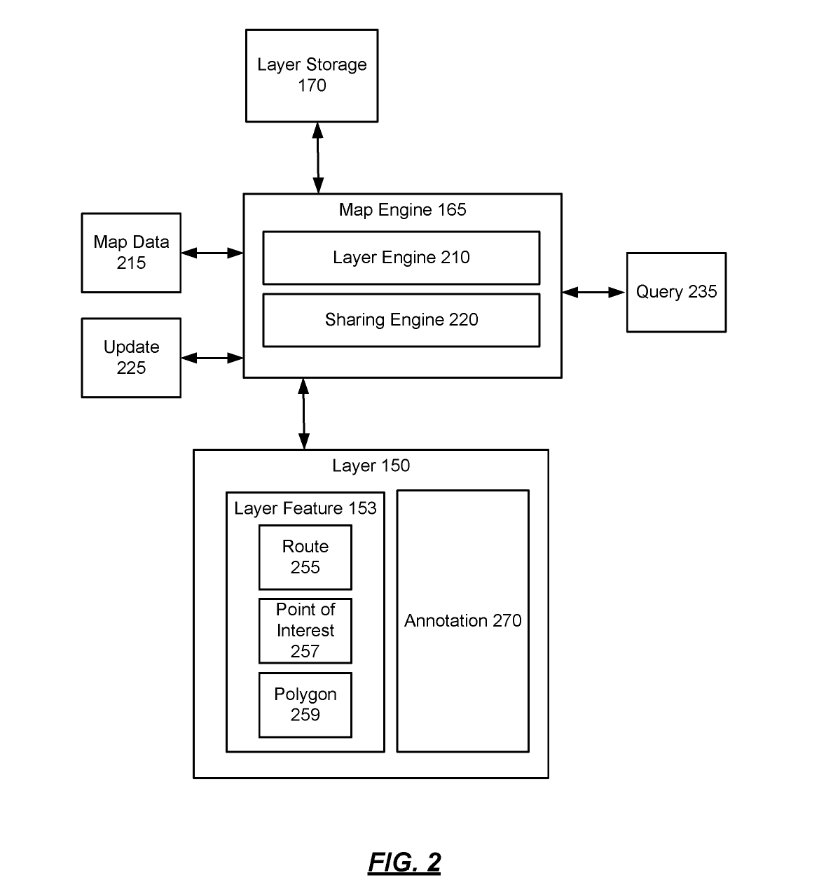

FIG. 2 is an illustration of an implementation of an exemplary map engine 165. The map engine 165 may include one or more components including a layer engine 210 and a sharing engine 220. More or fewer components may be included in the map engine 165. Some or all of the components of the map engine 165 may be implemented by one or more computing devices such as the computing device 1300 described with respect to FIG. 13. In addition, some or all of the functionality attributed to the map engine 165 may be performed by the map client 113, and vice versa.

The layer engine 210 may allow a user to create layers 150 for a map 140. In some implementations, the layer engine 210 may provide an application or user interface through which the user may create a desired layer 150. The user may create a layer 150 by selecting layer features 153 for the layer 150. The user may provide a name for the layer 150, and the generated layer 150 may be stored by the layer engine 210 in the layer storage 170.

The layer features 153 may include routes 255, points of interest 257, and polygons 259. A route 255 may be a path on the map 140 from an origin location to a destination location. The origin location and the destination locations may be the same locations or may be different locations.

The layer engine 210 may receive a route 255 selected by a user and may add the selected route 255 to the layer 150. In some implementations, the user may select a route 255 by providing a query 235 that includes the destination address and/or the origin address. The layer engine 210 may generate and display one or more routes 255 that can be used to travel from the origin address and the destination address. The layer engine 210 may generate the one or more routes 255 using map data 215 and a route 255 generation algorithms. The map data 215 may indicate roads that can be used to travel from the origin address to the destination address, and may also include traffic information such as historical traffic conditions and real-time traffic conditions.

The generated routes 255 may include a shortest route 255 by time, a shortest route 255 by distance, a scenic route 255, and a route 255 selected to avoid traffic. The user may select a preferred route 255 from the generated routes 255, and the layer engine 210 may add the selected route 255 to the layer features 153 of the layer 150.

Alternatively or additionally, the user may provide a route 255 by “drawing” the route 255 on the map 140. For example, the client device 110 may have a display with an interface that allows a user to provide input using a finger or a stylus. In another example, the map engine 113 may provide graphic design tools through which a user can draw one or more lines for a route 255. After drawing the route 255 on the map 140, the user can select the route 255 for the layer 150.

The point of interest 257 layer feature 153 may be an address or location on the map 140 that has been selected by the user. Points of interest 257 may include buildings, houses, businesses, and any other places or things that can be represented by a location or address on the map 140.

The layer engine 210 may receive a point of interest 257 selected by the user and may add the selected point of interest 257 to the layer 150. In some implementations, the user may select a point of interest 257 by touching or selecting a location on the map 140, and the selected location may be added to the layer 150 as a point of interest 257. The user may select the location using a finger or stylus, for example.

Alternatively or additionally, the user may select a point of interest 257 by providing a query 235 for a particular address, business name, or type of business. The layer engine 210 may identify and display one or more points of interest 257 that satisfy the query 235 using the map data 215. The user may select one or more points of interest 257 from the displayed points of interest 257, and the layer engine 210 may add the selected one or more points of interest 257 to the layer features 153 of the layer 150.

For example, a user may desire to add points of interest 257 to a layer 150 that correspond to drug stores near their house. The user may provide a query 235 of “Drug Stores” to the layer engine 210, and the layer engine 210 may display matching points of interest 257 from the map data 215 on the map 140. The user may select the points of interest 257 that are close to their house, and may add the selected points of interest 257 to the to the layer features 153 of the layer 150.

The polygon 259 layer feature 153 may be a shape that defines an area or region on the map 140. The polygons 259 may be used to identify areas such as neighborhoods, parks, tourist areas, or any other types of area.

The layer engine 210 may receive a polygon 259 generated by the user and may add the received polygon 259 to the layer 150. In some implementations, the user may generate a polygon 259 by drawing the polygon 259 on the map 140 using a finger or a stylus. Alternatively or additionally, the user may generate the polygon 259 using graphic design tools provided by the layer engine 210 and/or the map client 113.

For example, a user may be creating a layer 150 showing recommended neighborhoods for a tourist to visit. The user may “circle” each recommended neighborhood on the map using their finger, and the layer engine 210 may add a polygon 259 to the layer 150 for each circled neighborhood.

Alternatively or additionally, polygons 259 may be “pre-generated” by the layer engine 210 and/or map client 113. For example, the layer engine 210 may have pre-generated polygons 259 that correspond to buildings, venues, parks, neighborhoods, or any other location on the map 140. The user may view and select the pre-generated polygons 259 to add to the layer 150 from a menu or other user interface element, for example.

The layer engine 210 may further allow a user to provide annotations 270 for each layer feature 153. An annotation 270 may be a brief text description of the associated layer feature 153. The annotation 270 may be provided by the user when creating or selecting the layer feature 153 for the layer 150. For example, when the user is creating a route 255 that corresponds to a commute for the user, the user may provide the annotation 270 of “This is my work commute.” The layer engine 210 may associate the annotation 270 with the route 255. Later, when the user or another user is viewing the layer 150, the annotation 270 may be displayed along with the route 255. Alternatively, the annotation 270 may only be displayed when the user requests the annotation 270. For example, the annotation 270 may be displayed when the user selects the route 255 or provides some other indication that they would like to view the annotation 270.

The layer features 153 may include static layer features 153 and dynamic layer features 153. A static layer feature 153 may be a layer feature 153 whose associated content is fixed and does not change until actively changed by a user or creator. For example, if the user adds a static layer feature 153 such as a particular route 255 to the layer 150, each time the user, or another user, views the layer 150, the displayed route 255 will be the same.

In contrast, a dynamic layer feature 153 may be a layer feature 153 whose content is dynamic and is updated each time the associated layer 150 is viewed. For example, a user may add dynamic layer features 153 such as points of interest 257 that correspond to supermarkets to the layer 150. The dynamic layer features 153 may be associated with a query 235 such as “supermarkets.” Each time the layer 150 is opened or viewed by a user, the layer engine 210 may run the query 235 “supermarkets” and add the matching locations to the map 140 as points of interest 257.

In another example, a user may add a dynamic layer feature 153 such as a route 255 between an origin location and a destination location. Each time the layer 150 is opened or viewed by a user, the layer engine 210 may run a query 235 for the route 255 using the origin and destination location, and may add the recommended route 255 to the map 140. Because the route 255 may be generated based on map data 215 and may consider information such as current traffic conditions, the route 255 that is recommended may change depending on when the layer 150 is viewed.

In another example, dynamic layer features 153 may correspond to objects that do not have a fixed location on the map 150. These locations may include a current location of a user, or the current location of a popular food truck, for example. The queries 235 associated with these dynamic features 153 may be structured to cause the layer engine 210 to determine the current location of the dynamic features when the layer 150 is opened. Depending on the implementation, the locations may be determined using GPS, or based on information provided using one or more social networking applications. For example, popular food trucks may post their current locations in a feed or on a page associated with a social networking application.

There are advantages and disadvantages associated with both static and dynamic layer features 153. Static layer features 153 are fixed and therefore require less processing by the layer engine 210 to render than dynamic layer features 153. However, also because static layer features 153 are fixed, a user or creator must manually update the layer 150 when changes occur with respect to the layer features 153. For example, when a change such as a business associated with a point of interest 257 closes, the user creator may manually remove the point of interest 257 associated with the business from the layer 150. In contrast, if the closed business was a dynamic layer feature 153, the point of interest 257 associated with the business would automatically be removed from the layer 150.

The sharing engine 220 may facilitate the sharing of layers 150. For example, a user may generate a layer 150, and may use sharing engine 220 to share the generated layer 150 with one or more other users. The users may be selected from contacts or “friends” of the user in a social networking application. Other types of applications may be used. The sharing engine 220 may send the selected users links to the generated layer 150 in the layer storage 170, and the selected users may download the generated layer 150 from the layer storage 170 using the links. Alternatively or additionally, the sharing engine 220 may directly provide each selected user the generated layer 150. For example, the layer 150 may be sent as an attachment to an email or text message.

The sharing engine 220 may further provide a layer marketplace where users can browse and download generated layers 150. For example, users may browse layers 150 by keyword or subject matter.

The sharing engine 220 may provide updates 225 to users based on changes that are made to downloaded layers 150. When an owner or creator of a layer 150 stored on the layer storage 170 makes a change to the layer 150, the sharing engine 220 may generate an update 225 that includes the change. Depending on the implementation, the sharing engine 220 may “push” or provide the update 225 to each user that downloaded or was provided the layer 150, and the update 225 may be incorporated to the layer 150. Alternatively, the sharing engine 220 may alert each user that the update 225 was generated, and may make the update 225 available for each user to download.

For example, a creator of a layer 150 may send the layer 150 to several friends. Later, the user may change the layer 150 by adding a new point of interest 257. In response, the sharing engine 220 may generate an update 225 that includes the new point of interest 257, and may push the update 225 to each of the friends that downloaded the layer 150. The map client 113 associated with each friend may apply the update 225 to the layer 150, and the next time that the friends view or use the layer 150, the new point of interest 257 will be displayed on the map 140.

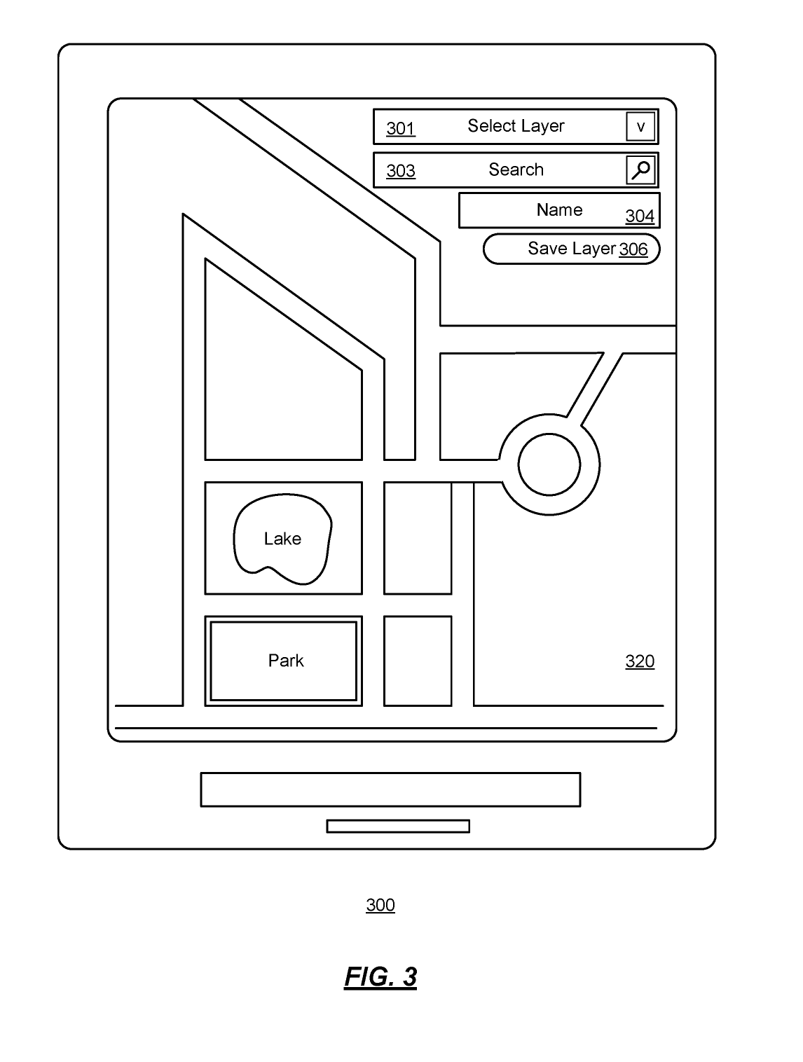

FIG. 3 is an illustration of an example user interface 300 for viewing a map 140 and for generating a layer 150. The user interface 300 may be implemented by a map client 113 executing on a client device 110. As shown, the user interface 300 is displayed on a tablet computing device. However, the user interface 300 may also be displayed by other computing devices such as smart phones and vehicle navigation systems.

As shown in a window 320, a user is viewing a map 140. Shown on the map 140 are various map features including various roads, a lake, and a park.

The user interface 300 includes user interface elements 301, 303, 304, and 306. The user interface element 301 labeled with the text “Select Layer” is a selection box that allows the user to select one or more layers 150 to apply to the map 140. If the user selects a layer 150 using the user interface element 301, the layer engine 210 of the map engine 165 may display the layer features 153 associated with the selected layer 150 on the map 140 in the window 320.

The user interface element 303 labeled with the text “Search” is a search box that allows the user to enter text for a query 235. Points of interest 257 and/or routes 255 that are responsive to the query 235 may be displayed on the map 140 in the window 320.

The user interface element 304 labeled with the text “Name” is a text box where the user can provide a name for a layer 150. The user interface element 306 labeled with the text “Save Layer” is a button that the user can select to save a layer 150 using the name provided in the user interface element 304. As described further below, the saved layer 150 may include some or all of the layer features 153 added by the user to the window 320.

A user of the user interface may desire to create a layer 150 that can be used by friends and family for an upcoming bike race that the user will be competing in. Accordingly, the user has used their map client 113 to display the map 140 that corresponds to a location that the bike race will take place.

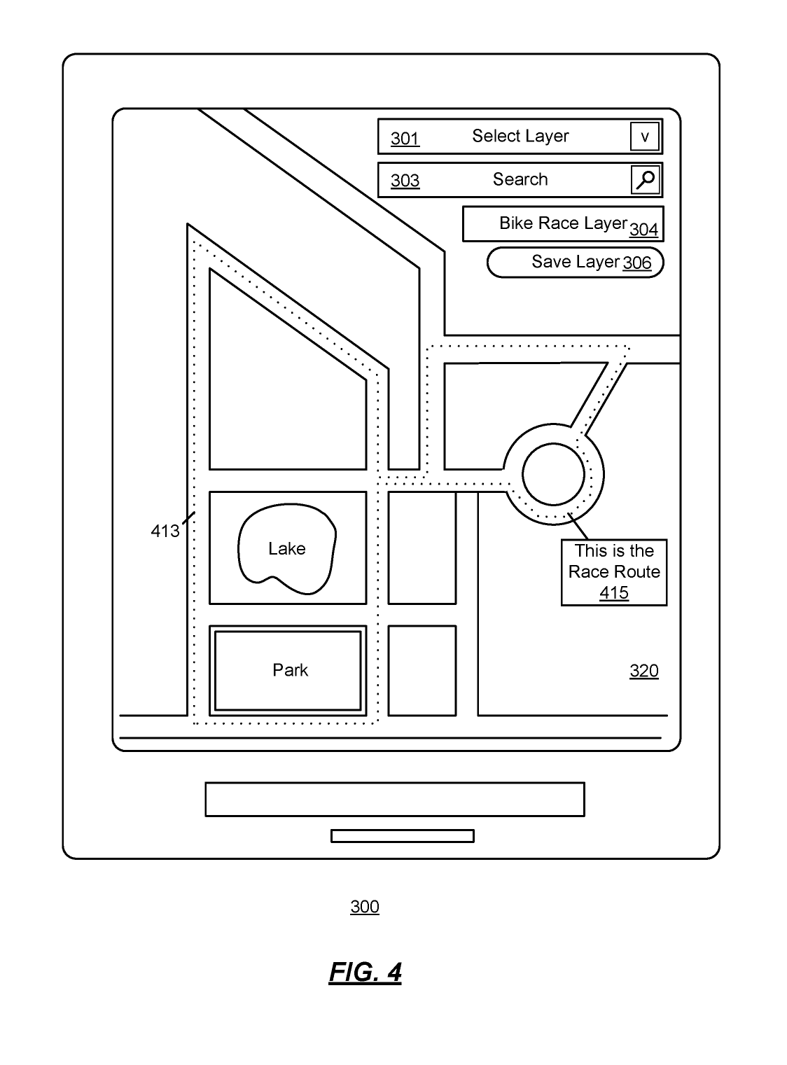

Continuing to FIG. 4, the user has begun to create a layer 150. In the example, shown, the user has provided the name “Bike Race Layer” into the user interface element 304 indicating that the name of the layer 150 will be “Bike Race Layer”.

The user has also added a route 255 to the window 320 that corresponds to the route that the race will travel on the map 140. The route 255 is shown in the window 320 as the dotted line 413. The user may have provided the route 255 by drawing the line 413 on a display associated with the client device 110 using their finger or a stylus. In the example shown, the route 255 is a static route and may only be changed by the user that is creating the layer 150.

In addition, the user has provided an annotation 270 for the route 255. As shown, the annotation 270 includes the text “This is the race route” and is shown in the window 320 by a user interface element 415.

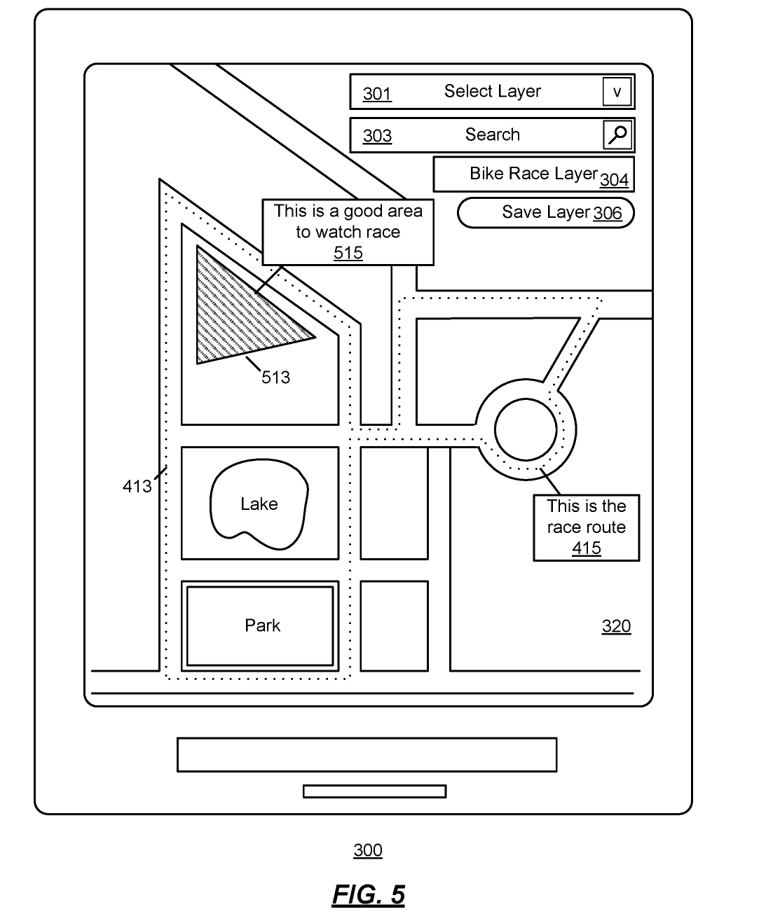

Continuing to FIG. 5, the user continues to create the layer 150 by adding layer features 153. The user has added a polygon 259 to the window 320 that defines an area on the map 140 that the user recommends for people to watch the race. The polygon 259 is shown on the map 140 as the area 513. Like the route 255, the user may have provided the polygon 259 by defining the boundaries of the area 513 using their finger or a stylus. Alternatively, the user may have selected the polygon 259 from one or more pre-generated polygons 259. The particular color or fill used for the area 513 may have been selected by the user. The annotation 270 for the polygon 259 is shown by a user interface element 515 and includes the text “This is a good area to watch the race”.

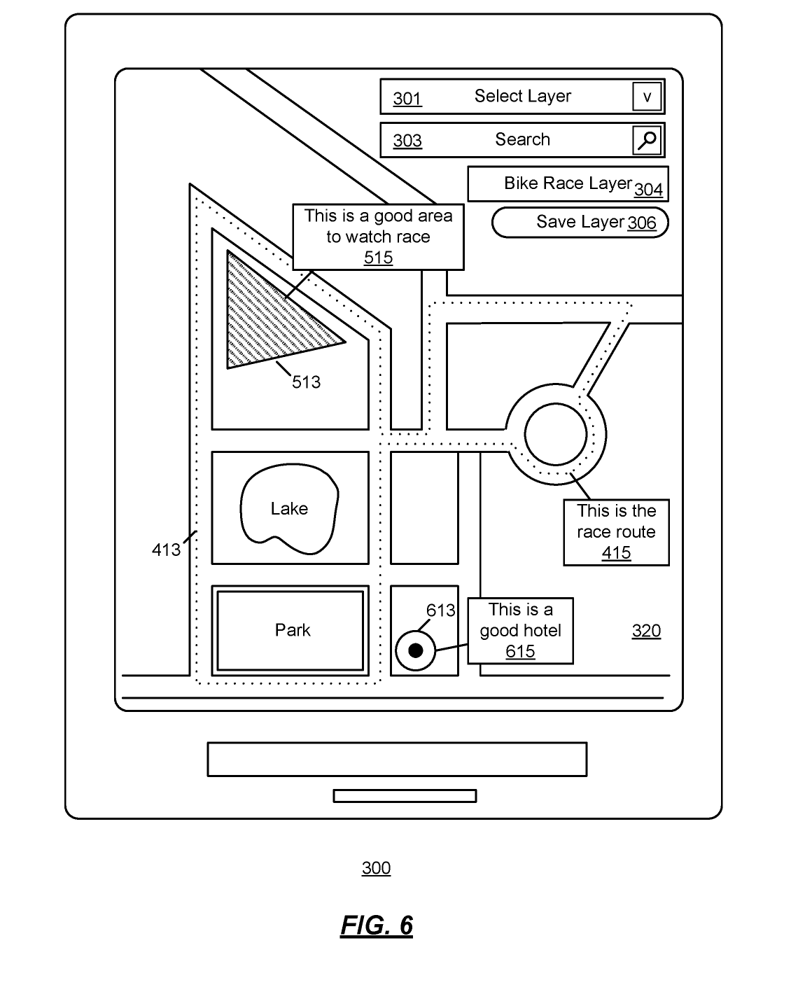

Continuing to FIG. 6, the user continues to create the layer 150 by adding layer features 153. The user has added a point of interest 257 to the window 320 that indicates a location of a hotel on the map 140 that the user recommends for people to stay. The point of interest 257 is shown on the map 140 as a target 613. Like the route 255 and the polygon 259, the user may have provided the point of interest 257 using their finger or a stylus. The annotation 270 for the point of interest 257 is shown by a user interface element 615 and includes the text “This is a good hotel”. In the example shown, the point of interest 257 is a static point of interest 257 and may only be changed by the user that is creating the layer 150.

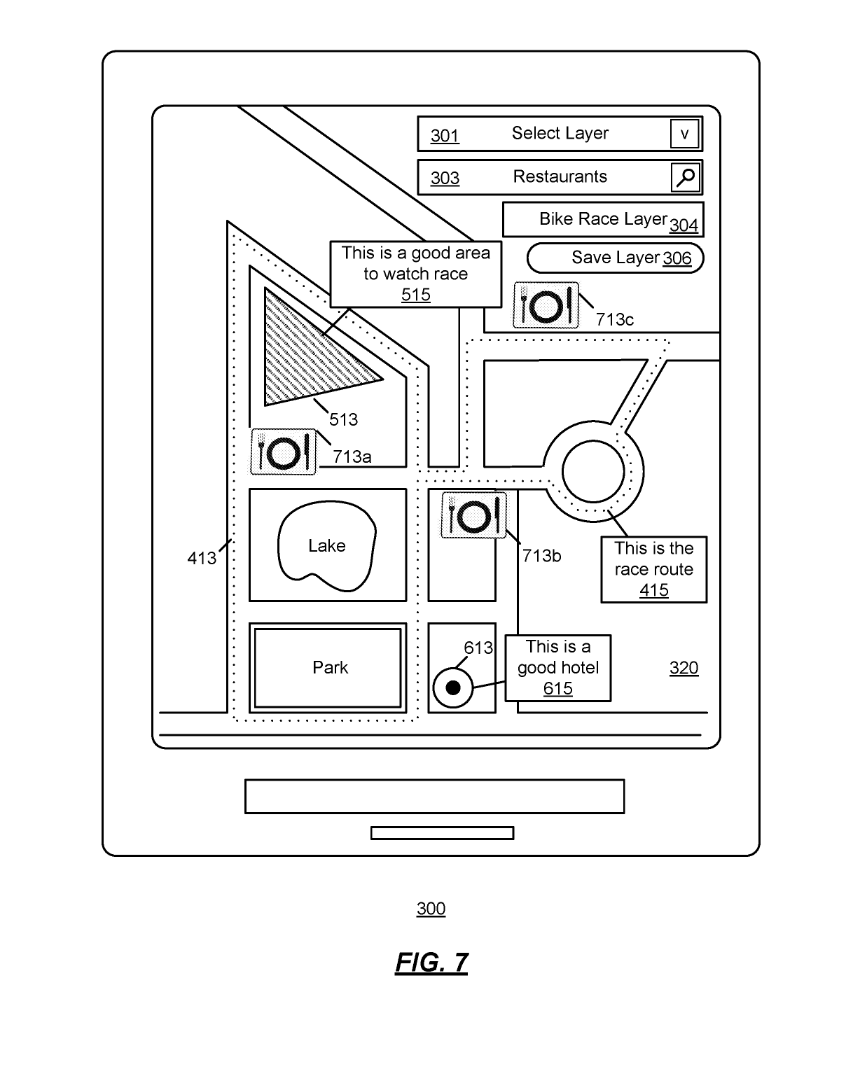

Continuing to FIG. 7, the user continues to create the layer 150 by adding layer features 153. The user has added multiple points of interest 257 to the window 320 that each indicate the location of a restaurant on the map 140 that is close to the location of the race. Each restaurant is shown by an icon 713 (i.e., the icons 713a, 713b, and 713c) that is stylized to look like a place setting.

Unlike the previous layer features 153 added to the map 140, these points of interest 257 are dynamic layer features 153. As shown in the user interface element 303, the user provided the query 235 of “Restaurants”, and in response the icons 713 were displayed on the map 140 in the window 320. Also unlike the previous layer features 153, the user has elected not to provide any annotations 270 for the points of interest 257.

After the user has finished adding layer features 153, the user may select the user interface element 306 labeled “Save Layer”. In response, the layer engine 210 completes the layer 150 and stores the layer 150 in the layer storage 170. The user may also use the sharing engine 220 to provide a copy of the generated layer 150 to friends and family that are coming to the bike race.

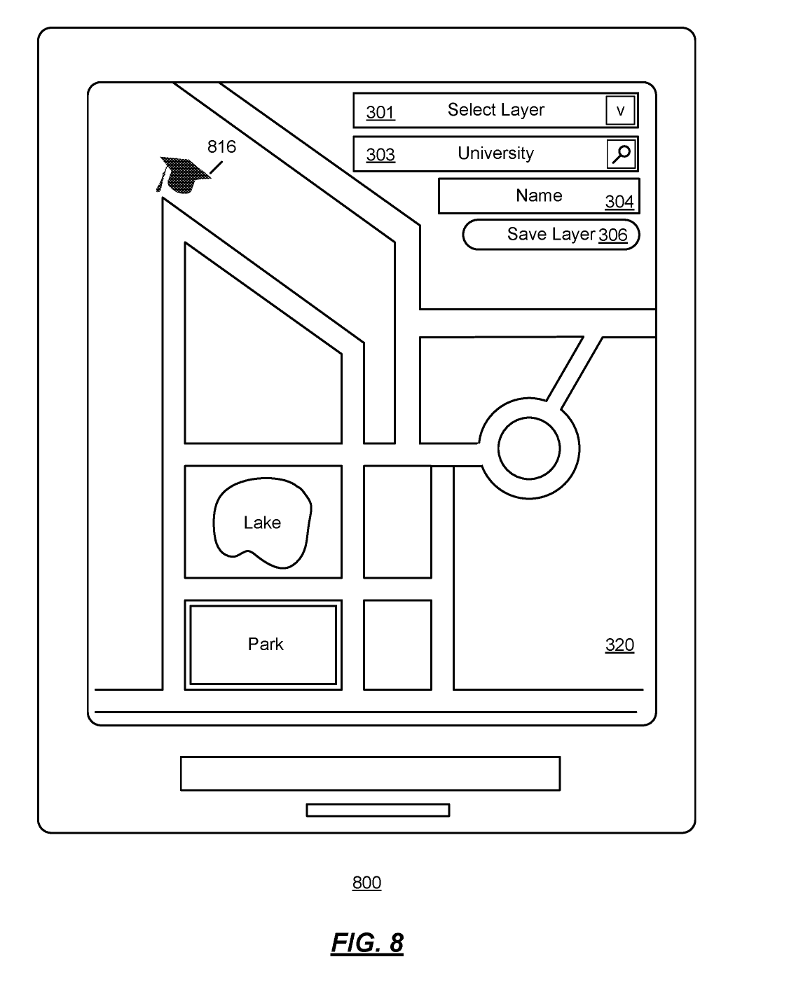

Continuing to FIG. 8, an example user interface 800 is shown that is used by a friend of the user that created the layer 150 for the bike race. Similar to the user interface 300, the user interface 800 includes the user interface elements 301, 303, 304, and 306, and the window 320. The user interface 800 may also be implemented by a map client 113 executing on a client device 110.

The friend of the user is viewing the map 140 associated with the location of the upcoming bike race. The friend may have received the layer 150 “Bike Race Layer” generated by the user, but the layer 150 is not active as indicated by the user interface element 301.

As shown, the user has provided the query 235 “University” into the user interface element 303. In response, an icon 816 is displayed on the map 140 in the window 320 that corresponds to a local university that is close to the bike race. The icon 816 is stylized to look like a graduation cap.

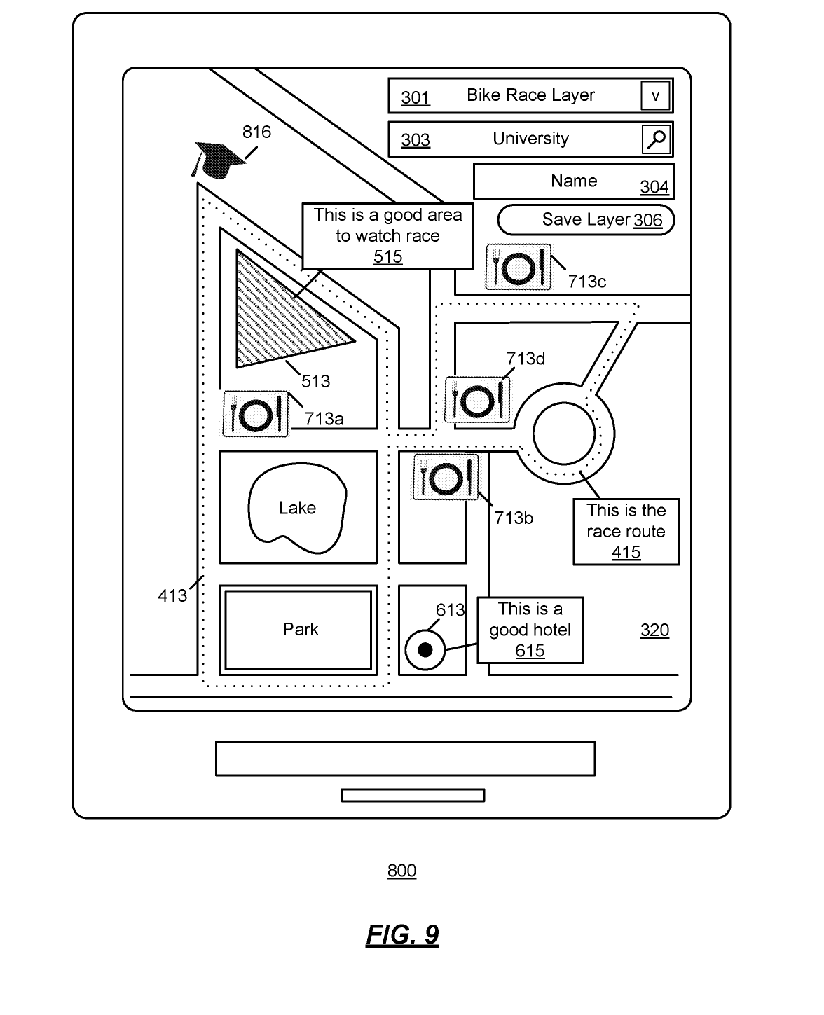

Continuing to FIG. 9, the friend has decided to activate the received layer 150 by selecting “Bike Race Layer” in the user interface element 301. In response, the various layer features 153 that are associated with the layer 150 are displayed on the map 140 in the window 320. For example, the window 320 includes the icon 613 corresponding to the hotel point of interest, the area 513 corresponding to the polygon 259, and the line 415 corresponding to the route 255. Because these layer features 153 are static layer features 153 they are the same as the original layer features 153 added by the creator of the layer 150. Also shown are the corresponding annotations 270. In addition, the icon 816 corresponding to the query 235 “University” remains displayed in the window 320 after the layer features 153 of layer 150 are displayed.

The window 320 further includes the icons 713 corresponding to the restaurant points of interest 257 added by the user. Because these layer features 53 are dynamic layer features 153, the icons 713 are different than the icons 713 displayed in FIG. 7. In particular, the icons 713 now include an icon 713d in addition to the icons 713a-c. The icon 713d may correspond to a restaurant that was opened, or was added to the map data 215, after the user created the layer 150. When the friend opened the layer 150 on their respective client device 110, the layer engine 210 executed the “Restaurant” query 235, and added an icon 713 to the map 140 in the window 320 for each restaurant location that was responsive to the query 235.

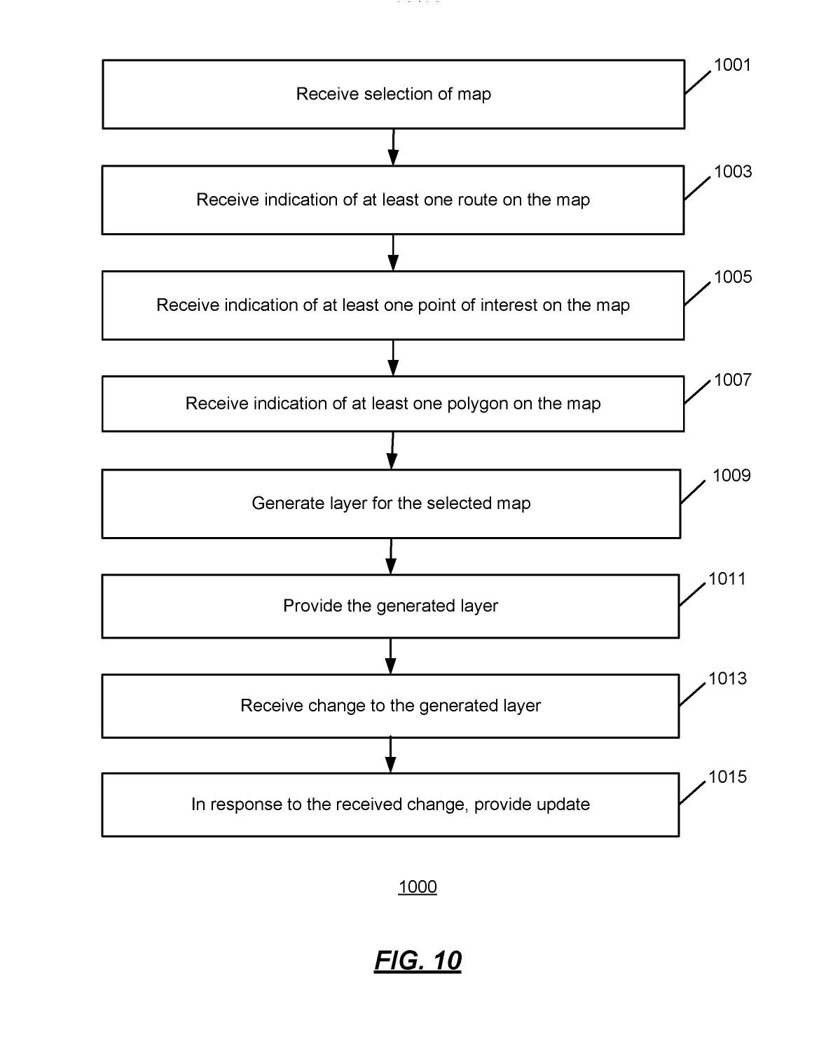

FIG. 10 is an operational flow of an implementation of a method 1000 for generating a layer and for updating the layer based on a received change. The method 1000 may be implemented by the map engine 165 and/or the map client 113.

At 1001, a selection of a map is received. The selection of the map 140 may be received by the map engine 165. For example, a user may select a map 140 by entering an address into a map application.

At 1003, an indication of at least one route on the map is received. The indication of the at least one route 255 may be received by the layer engine 210 of the map engine 165. For example, the user may provide the indication of the at least one route 255 by drawing the route 255 on a display of a client device 110.

At 1005, an indication of at least one point of interest on the map is received. The indication of the at least one point of interest 257 may be received by the layer engine 210 of the map engine 165. For example, the user may provide the indication of the at least one point of interest 257 by touching a location of the point of interest 257 on the display of the client device 110.

At 1007, an indication of at least one polygon on the map is received. The indication of the at least one polygon 259 may be received by the layer engine 210 of the map engine 165. For example, the user may provide the indication of the at least one polygon 259 by drawing the boundaries of the polygon 259 on the display of the client device 110. Alternatively, the user may provide the indication by selecting the polygon 259 from a list or menu of pre-generated polygons 259.

At 1009, a layer is generated for the selected map. The layer 150 may be generated by the layer engine 210 of the map engine 165. The layer 150 may be generated by adding the at least one route 255, the at least one point of interest 257, and the at least one polygon 259 to the layer 150. More or fewer features may be included in the layer 150.

At 1011, the generated layer is provided. The generated layer 150 may be provided to at least one user of a plurality of users by the sharing engine 220. The at least one user of the plurality of users may be a different user than the user that provided the at least one route 255, the at least one point of interest 257, and the at least one polygon 259.

At 1013, a change to the generated layer is received. The change to the generated layer 150 may be received by the layer engine 210 of the map engine 165. The change may include adding or removing a route 255, a point of interest 257, or a polygon 259 to or from the layer 150.

At 1015, an update is provided in response to the received change. The update 225 may be provided to the at least one user of the plurality of users that was provided the generated layer. The update 225 may include the change to the generated layer 150.

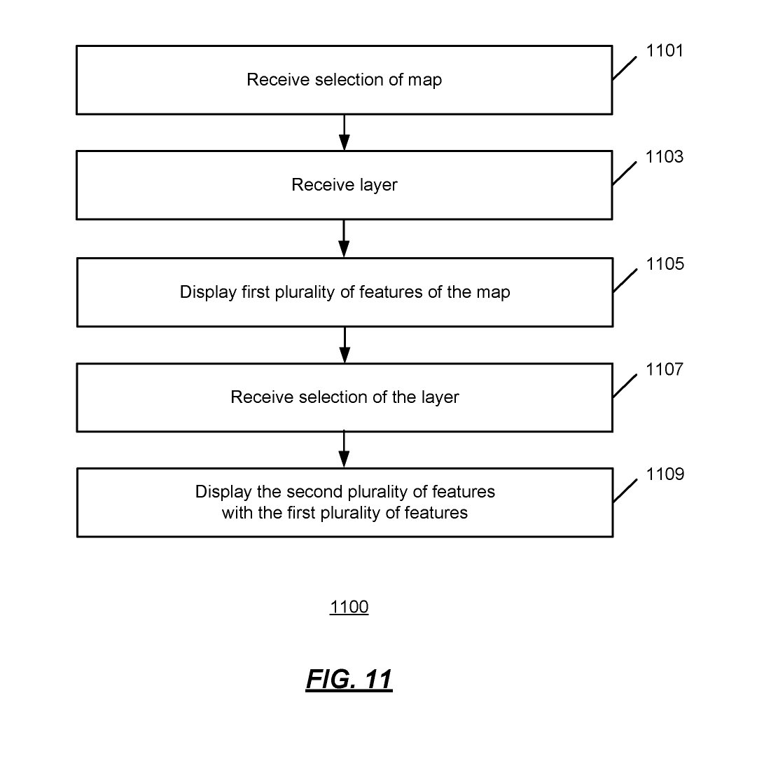

FIG. 11 is an operational flow of an implementation of a method 1100 for receiving a layer, and for displaying a map with the received layer. The method 1100 may be implemented by the map engine 165 and/or the map client 113.

At 1101, a selection of a map is received. The selection of the map 140 may be received by the map client 113 from a user. For example, a user may select a map 140 by entering an address into the map client 113. The map 140 may include a first plurality of features (i.e., map features 143). The map client 113 may be executed on a client device 110 that is associated with the user.

At 1103, a layer is received. The layer 150 may be received by the map client 113 from the sharing engine 220 of the map engine 165. The layer 150 may have been generated by a user that is different than the user that selected the map 140. The layer 150 may include a second plurality of features (i.e., layer features 153). The second plurality of features may include one or more of a route 255, a point of interest 257, or a polygon 259.

At 1105, the first plurality of features of the map are displayed. The first plurality of features may be displayed by the map client 113 on a display associated with the client device 110.

At 1107, a selection of the layer is received. The selection of the received layer 150 may be received by the map client 113 by the user that selected the map 140. For example, the user may select the layer 150 from a list of layers 150 that have been received by the user.

At 1109, the second plurality of features is displayed with the first plurality of features. The second plurality of features may be displayed by the map client 113 on the display associated with the client device 110. The second plurality of features may be displayed on top of the first plurality of features.

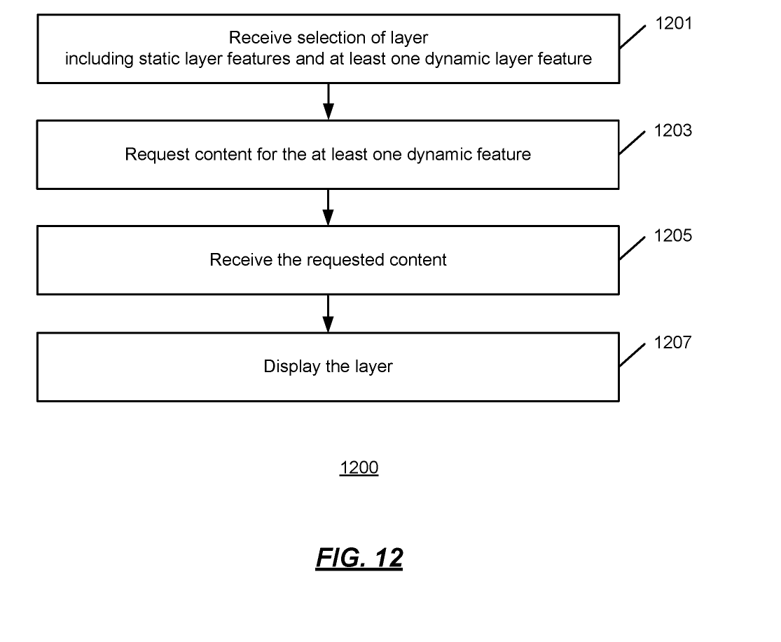

FIG. 12 is an operational flow of an implementation of a method 1200 for displaying a map with a received layer. The method 1200 may be implemented by the map engine 165 and/or the map client 113.

At 1201, a selection of a layer is received. The layer 150 may be selected by a user of a map client 113. The layer 150 may include a plurality of layer features 153. The layer features 153 may include static layer features 153 and at least one dynamic layer feature 153.

At 1203, content for the at least one dynamic feature is requested. The content for the at least one dynamic layer feature 153 may be requested by the layer engine 210 of the map engine 150. Depending on the implementation, the at least one dynamic layer feature 153 may be associated with a query 235, and the content for the at least one dynamic layer feature 153 may be requested by running the associated query 235 on map data 215, for example.

At 1205, the requested content is received. The requested content may be received by the map client 113.

At 1207, the layer is displayed. The layer 150 may be displayed by the map client 113. The displayed layer 150 may include each of the associated layer features 153 and the received content for the at least one dynamic layer feature 153.

FIG. 13 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 13, an exemplary system for implementing aspects described herein includes a computing device, such as computing device 1300. In its most basic configuration, computing device 1300 typically includes at least one processing unit 1302 and memory 1304. Depending on the exact configuration and type of computing device, memory 1304 may be volatile (such as random access memory (RAM)), non-volatile (such as read-only memory (ROM), flash memory, etc.), or some combination of the two. This most basic configuration is illustrated in FIG. 13 by dashed line 1306.

Computing device 1300 may have additional features/functionality. For example, computing device 1300 may include additional storage (removable and/or non-removable) including, but not limited to, magnetic or optical disks or tape. Such additional storage is illustrated in FIG. 13 by removable storage 1308 and non-removable storage 1310.

Computing device 1300 typically includes a variety of computer readable media. Computer readable media can be any available media that can be accessed by the device 1300 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 1304, removable storage 1308, and non-removable storage 1310 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1100. Any such computer storage media may be part of computing device 1300.

Computing device 1300 may contain communication connection(s) 1312 that allow the device to communicate with other devices. Computing device 1300 may also have input device(s) 1314 such as a keyboard, mouse, pen, voice input device, touch input device, etc. Output device(s) 1316 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In an implementation, a system for generating a layer for a map and for providing the generated layer is provided. The system includes at least one computing device and a map engine. The map engine may be adapted to: receive a selection of a map; receive an indication of at least one route on the map; receive an indication of at least one point of interest on the map; receive an indication of at least one polygon on the map; generate a layer for the selected map comprising the at least one route, the at least one point of interest, and the at least one polygon; and provide the generated layer.

Implementations may include some or all of the following features. The map engine may be further adapted to: display the map; receive a selection of the layer; and in response to the selection, display the selected layer on top of the displayed map. The map engine adapted to display the map may include the map engine adapted to display the map including one or more features of the map, and wherein the map engine adapted to display the selected layer on top of the displayed map may include the map engine adapted to display the selected layer on top of the one or more features of the map. The indication of the at least one polygon may include user input drawing the at least one polygon on a display associated with the at least one computing device. The map engine adapted to receive the indication of at least one point of interest on the map may include the map engine adapted to receive results of a query, and to determine the at least one point of interest based on the received results of the query. The generated layer may be provided to a plurality of users. The map engine may be further adapted to: receive a change to the generated layer, and in response to the received change, provide an update to each user of the plurality of users that was provided the generated layer. Providing the update to each user may include pushing the update to each user.

In an implementation, a system for selecting a layer for a map and for displaying the selected layer on the map is provided. The system may include at least one computing device and a map engine. The map engine may be adapted to: receive a selection of a map comprising a first plurality of features; display the first plurality of features of the map; receive a selection of a layer comprising a second plurality of features, wherein the second plurality of features includes at least one dynamic feature; and in response to the selection of the layer: request content for the at least one dynamic feature; receive the content for the at least one dynamic feature; and display the second plurality of features on the map with the first plurality of features, wherein the second plurality of features includes the content for the at least one dynamic feature.

Implementations may include some or all of the following features. The map engine may be further adapted to: receive the layer from a user; receive a change to at least one feature of the second plurality of features from the user; and in response to the received change, display the second plurality of features on the map with the received change. The map engine adapted to request content for the at least one dynamic feature may include the map engine adapted to run a query associated with the at least one dynamic feature. The second plurality of features may include one or more of a route, a point of interest, and a polygon. The map engine may be further adapted to: receive a feature; add the received feature to the second plurality of features; and provide the added feature to one or more users associated with the selected layer. The received feature may include a route, and the route may be based on user input drawing the route on a display associated with the at least one computing device.

In an implementation, a method for generating a layer for a map and for displaying the layer on the map is provided. The method includes: receiving indications of a plurality of features on a map by a computing device; generating a layer for the map comprising the plurality of features by the computing device; providing the generated layer to a plurality of users by the computing device; receiving a change to one or more of the plurality of features by the computing device; and in response to the received change, providing an update to one or more users of the plurality of users by the computing device.

Implementations may include some or all of the following features. The method may further include displaying the map; receiving a selection of the layer; and in response to the selection, displaying the selected layer on top of the displayed map. Receiving the indications of the plurality of features may include receiving an indication of at least one route on the map; receiving an indication of at least one point of interest on the map; and receiving an indication of at least one polygon on the map. Receiving the indication of the at least one polygon may include receiving user input drawing the at least one polygon on a display associated with the computing device. Receiving the indication of the at least one point of interest on the map may include receiving results of a query, and determining the at least one point of interest based on the received results of the query. The method may further include receiving an annotation for the indication of the at least one polygon, and generating the layer for the map comprising the received annotation.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system for generating a layer for a map, and for providing the generated layer, the system comprising:
at least one computing device; and
a map engine adapted to:
receive a selection of a map;
receive, from a user computing device, an indication of at least one route on the map, an indication of at least one point of interest on the map, and an indication of at least one polygon on the map;
generate a layer for the selected map comprising a plurality of static features and dynamic features, wherein the static features and the dynamic features comprise the at least one route, the at least one point of interest, and the at least one polygon;
provide the generated layer to a plurality of other user computing devices;
receive an update to one of the dynamic features;
change the generated layer responsive to the update; and
provide the changed generated layer to the user computing device and to the plurality of other user computing devices.

2. The system of claim 1, wherein the map engine is further adapted to:
display the map;
receive a selection of the layer; and
in response to the selection, display the selected layer on top of the displayed map.

3. The system of claim 2, wherein the map engine adapted to display the map comprises the map engine adapted to display the map including one or more features of the map, and wherein the map engine adapted to display the selected layer on top of the displayed map comprises the map engine adapted to display the selected layer on top of the one or more features of the map.

4. The system of claim 1, wherein the indication of the at least one polygon comprises user input drawing the at least one polygon on a display associated with the at least one computing device.

5. The system of claim 1, wherein the map engine adapted to receive the indication of at least one point of interest on the map comprises the map engine adapted to receive results of a query, and to determine the at least one point of interest based on the received results of the query.

6. The system of claim 1, wherein the generated layer is provided to a plurality of users.

7. The system of claim 6, wherein the map engine is further adapted to:
receive a change to the generated layer, and
in response to the received change, provide an update to each user of the plurality of users that was provided the generated layer.

8. The system of claim 7, wherein providing the update to each user comprises pushing the update to each user.

9. A system for selecting a layer for a map, and for displaying the selected layer on the map, the system comprising:
at least one computing device; and
a map engine adapted to:
receive a selection of a map comprising a first plurality of features;
display the first plurality of features of the map;
receive a selection of a layer comprising a second plurality of features, wherein the second plurality of features includes at least one dynamic feature received from a user computing device;
in response to the selection of the layer:
request content for the at least one dynamic feature;
receive the content for the at least one dynamic feature; and
display the second plurality of features on the map with the first plurality of features, wherein the second plurality of features includes the content for the at least one dynamic feature;
provide the layer to a plurality of other user computing devices;
receive an update to the at least one dynamic feature;
change the layer responsive to the update; and
provide the changed layer to the user computing device and to the plurality of other user computing devices.

10. The system of claim 9, wherein the map engine is further adapted to:
receive the layer from a user;
receive a change to at least one feature of the second plurality of features from the user; and
in response to the received change, display the second plurality of features on the map with the received change.

11. The system of claim 9, wherein the map engine adapted to request content for the at least one dynamic feature comprises the map engine adapted to run a query associated with the at least one dynamic feature.

12. The system of claim 9, wherein the second plurality of features comprises one or more of a route, a point of interest, and a polygon.

13. The system of claim 9, wherein the map engine is further adapted to:
receive a feature;
add the received feature to the second plurality of features; and
provide the added feature to one or more users associated with the selected layer.

14. The system of claim 13, wherein the received feature comprises a route, and the route is based on user input drawing the route on a display associated with the at least one computing device.

15. A method for generating a layer for a map, and for displaying the layer on the map, the method comprising:
receiving, from a user computing device, indications of a plurality of static features and dynamic features on a map by a computing device;
generating a layer for the map comprising the plurality of static features and dynamic features by the computing device;
providing the generated layer to a plurality of other user computing devices by the computing device;
receiving an update to one of the dynamic features by the computing device;
changing the generated layer responsive to the update; and
in response to the received update, providing the changed generated layer to the user computing device and to the plurality of other user computing devices.

16. The method of claim 15, further comprising:
displaying the map;
receiving a selection of the layer; and
in response to the selection, displaying the selected layer on top of the displayed map.

17. The method of claim 15, wherein receiving the indications of the plurality of static features and dynamic features comprises:
receiving an indication of at least one route on the map;
receiving an indication of at least one point of interest on the map; and
receiving an indication of at least one polygon on the map.

18. The method of claim 17, wherein receiving the indication of the at least one polygon comprises receiving user input drawing the at least one polygon on a display associated with the computing device.

19. The method of claim 17, wherein receiving the indication of the at least one point of interest on the map comprises receiving results of a query, and determining the at least one point of interest based on the received results of the query.

20. The method of claim 17, further comprising receiving an annotation for the indication of the at least one polygon, and generating the layer for the map comprising the received annotation.
